(19) United States
(12) Patent Application Publication
(10) Pub. No.: US 2022/0185001 A1
(43) Pub. Date: Jun. 16, 2022

(54) ACTIVATING AGENT COMPOSITION FOR WATER PRESSURE TRANSFER, WATER PRESSURE TRANSFER METHOD AND WATER PRESSURE TRANSFER PRODUCT

(71) Applicant: TAICA CORPORATION, Tokyo (JP)

(72) Inventors: Ryuichi KAMEI, Shizuoka-shi (JP); Masaki SHIGENAI, Shizuoka-shi (JP)

(21) Appl. No.: 17/438,607

(22) PCT Filed: Mar. 13, 2020
(86) PCT No.: PCT/JP2020/011065

§ 371 Date: Sep. 13, 2021

(30) Foreign Application Priority Data
Mar. 25, 2019 (JP) 2019-056402

(51) Int. Cl. B44C 1/175

(52) U.S. Cl. CPC B44C 1/1758

(57) ABSTRACT

In order to satisfy the requirements necessary for a plasticizer of an activating agent for water pressure transfer, to avoid concerns about environmental load and to prevent bubbles from being generated when a carrier film is removed, there is provided an activating agent composition for activating a print pattern layer of a transfer film for the water pressure transfer by applying it to the print pattern layer of the transfer film for water pressure transfer, the activating agent composition comprising a resin component, a solvent component and a plasticizer component, wherein the plasticizer component is a non-aromatic carboxylic acid ester or carboxylic acid ether ester having two or more carboxylate groups, and the molecular weight ratio obtained by dividing the sum of the molecular weights of the terminal side aliphatic hydrocarbon groups forming ester bonds and/or the furthest terminal side aliphatic hydrocarbon groups constituting ether bonds by the molecular weight of the carboxylic acid ester or carboxylic acid ether ester is 0.3 or more.

### TECHNICAL FIELD

This invention relates to an activating agent composition for activating a print pattern layer of a water pressure transfer film by applying the activating agent composition onto the dry print pattern layer to thereby restore an adhesiveness of the print pattern layer. More particularly, this invention relates to a solvent-based activating agent composition for activating an ink in a print pattern layer by a solvent component, and in particular, an activating agent composition for reducing the environmental load, a water pressure method using the activating agent composition, and a water pressure transfer product manufactured by this method.

### BACKGROUND OF THE INVENTION

In general, a solvent-based activating agent composition contains a resin component, a solvent component and a plasticizer component and some examples of such an activating agent composition according to the prior arts are disclosed in Patent Documents 1 and 2 (Official gazettes of Japanese Patent No. 3366149 and Japanese Patent No. 3385576). In these prior arts, the resin component comprises short oil alkyd resin and cellulose acetobutyrate (CAB), which ensures an initial adhesion of ink in the print pattern layer to a substrate (article to be pattern-transferred) and prevents ink's diffusion, the solvent component comprises butyl cellosolve and butyl carbitol acetate, which dissolves the ink in the print pattern layer to ensure the adhesion of the ink until the transfer of the print pattern is completed and the plasticizer comprises dibutyl phthalate (DBP), which provides a plasticity to the resin component of the ink to ensure the extensibility of the print pattern layer during water pressure transfer.

As aforementioned, the plasticizer of the activating agent composition disclosed in Patent Documents 1 and 2 comprises the dibutyl phthalate, which is also used in other conventional activating agent compositions (see Patent Documents 4 and 5). However, dibutyl phthalate has been designated as a substance of very high concern for environmental load (SVHC) as defined in the REACH (Registration, Evaluation, Authorization and Restriction of Chemicals) of the EU regulation and its use will be restricted in the future not only in Europe but also in other countries including Japan. Thus, it is desired to avoid the use of dibutyl phthalate as the plasticizer.

On the other hand, the plasticizer for the activating agent composition is required to have at least four following necessary conditions: (1) excellent plasticization of the resin component, (2) good contact (throwing ability) of the ink-activated transfer film around the surface of the substrate to be pattern-transferred during water pressure transfer, (3) excellent adhesion of the print pattern layer to the substrate and (4) difficulty in bleeding (exudation) of the plasticizer from the surface of the water pressure pattern-transferred product after transfer.

The applicant has proposed an activating agent composition that can meet the above four conditions with plasticizer components other than dibutyl phthalate. In the proposed activating agent composition disclosed in Patent Document 5 (Japanese Patent No. 5276237) there has been used a component of benzoate or phosphate ester in place of dibutyl phthalate as plasticizers

However, the benzoic ester or phosphate ester plasticizer causes the water-soluble carrier film (PVA film) of the transfer film to foam remarkably in a film removal process where the carrier film (PVA film) is water-washed and removed from the water pressure transfer product in a film removal tank due to a PVA contained water cleaning solution caused by dissolving the carrier film with water. This causes the water cleaning solution to overflow from the film removal tank, which occurs a problem in the stable production of water pressure transfer products. In order to solve this problem, an attempt has been made to add a defoaming agent to suppress the generation of bubbles in the film removal tank, but it has not been possible to achieve a sufficient defoaming effect.

### PRIOR ART LITERATURE

### Patent Document

Patent Document 1; JP3366149B
Patent Document 2; JP3385576B
Patent Document 3: JP2008-247007A.
Patent Document 4: JP2010-83048A
Patent Document 5; JP5276237B

### SUMMARY OF THE INVENTION

### Problem to be Solved by the Invention

A first problem to be solved by the present invention is to provide an activating agent composition for water pressure transfer containing a plasticizer that can satisfy the necessary conditions for the plasticizer, can avoid concerns for the environmental load and can suppress the generation of bubbles when the carrier film is removed.

A second problem to be solved by the present invention is to provide a water pressure transfer method for transferring a print pattern layer onto an article using an activating agent composition for water pressure transfer containing a plasticizer that can satisfy the necessary conditions of the plasticizer, can avoid concerns about the environmental load and can suppress the generation of bubbles when the carrier film is removed.

A third problem to be solved by the present invention is to provide a water pressure transfer product having a decorative layer obtained by a print pattern layer transferred under water pressure using an activating agent composition for water pressure transfer containing a plasticizer that can satisfy the necessary conditions of the plasticizer, can avoid concerns about environmental load and can suppress the generation of bubbles when the carrier film is removed.

### Means for Solving the Problems

The means for solving the first problem of the present invention is an activating agent composition for water pressure transfer, which is applied to a print pattern layer of a transfer film for water pressure transfer to activate said print pattern layer and comprises a resin component, a solvent component and a plasticizer component, and characterized by that the plasticizer component is a non-aromatic carboxylic acid ester or carboxylic acid ether ester having two or more carboxylate groups, and the molecular weight ratio obtained by dividing the sum of the molecular weights of the terminal side aliphatic hydrocarbon groups forming ester bonds and/or the furthest terminal side aliphatic hydrocarbon groups forming ether bonds by the molecular weight of the carboxylic acid ester or carboxylic acid ether ester is 0.3 or more.

In the first problem solving means of the present invention, the plasticizer component may comprise a main plasticizer component and a single or multiple sub-plasticizer components, and the sub-plasticizer component may have a molecular weight ratio lower than that of the main plasticizer component.

In this case, the difference between the molecular weight ratio of the main plasticizer component and the molecular weight ratio of the sub-plasticizer component may be preferably 0.05-0.25.

In the first problem solving means of the present invention, it is preferable that the weight ratio of said plasticizer component relative to the entire activating agent composition may be 13-25%.

In the case where the plasticizer comprises the main plasticizer component and the sub-plasticizer component, it is preferable that the weight ratio of said main plasticizer component relative to the entire plasticizer may be 65-80%.

In the first problem solving means of the present invention, the carboxylic acid comprising said carboxylic acid ester or carboxylic acid ether ester may be selected from maleic acid and succinic acid.

The means for solving the second problem of the present invention is to provide a method for transferring under water pressure a print pattern layer of a transfer film for water pressure transfer onto an article using an activating agent composition according to the first problem solving means.

The means for solving the third problem of the present invention is to provide a water pressure transfer article having a decorative layer obtained by water pressure transfer of a print pattern layer of a water pressure transfer film according to the second problem solving means.

### Effect of the Invention

According to the present invention, since the plasticizer of the activating agent composition comprises a carboxylic acid ester or a carboxylic acid ether ester having two or more carboxyl groups, there can be avoided the use of dibutyl phthalate, which is a substance of very high concern (SVHC) for the environmental load in the REACH of EU regulations.

In addition, in the case where the molecular weight ratio, which is calculated by dividing the sum of the molecular weights of the terminal side aliphatic hydrocarbon groups forming ester bonds and/or the furthest terminal side aliphatic hydrocarbon groups forming ether bonds by the molecular weight of the carboxylic acid ester or carboxylic acid ether ester is 0.3 or more, there will be suppressed a generation of bubbles due to the dissolution of the carrier film during the film removal process. Thus, there is no need to add a defoaming agent within the film removal tank, and stable operation of the film removal process can be achieved. The effect of suppressing the generation of bubbles will be described in detail together with an explanation of examples.

### BRIEF DESCRIPTION OF THE DRAWINGS

FIG. 1 shows a schematic diagram of a method for transferring under water pressure a print pattern layer of a transfer film onto an article using the activating agent composition of the present invention;

FIG. 2 schematically shows the steps of the method of FIG. 1; and

FIG. 3: is an enlarged cross-sectional view of the article with a decorative layer obtained by the method of FIG. 2.

### MODE OF EMBODYING THE INVENTION

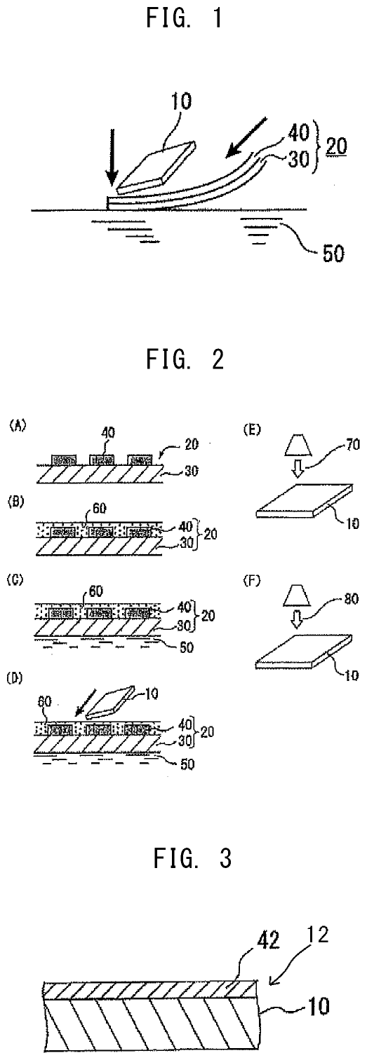

Explaining the mode of embodiments of the invention in detail with reference to the drawings, FIG. 1 briefly shows a water pressure transfer method in which an activating agent composition for water pressure transfer of the invention is used. In this water pressure transfer method, the transfer film 20 comprising a water-soluble film (carrier film) 30 having a print pattern layer 40 applied thereon, is supplied and floated on water 50 in a transfer tank so that the print pattern layer 40 becomes the upper surface, and the article 10 to be pattern-transferred under water pressure is forced into the water 50 through the transfer film 20 to thereby perform the water pressure transfer method.

The water-soluble film 30 absorbs the water to be moistened and softened. For example, it is made of a water-soluble material having polyvinyl alcohol (PVA) included as a main component. This water-soluble film 30 is softened in contact with the water 50 within the transfer tank during water pressure transfer and closely contacts the outer surface of the article to be decorated so as to enable water pressure transfer to be performed. The print pattern layer 40 may be applied on the water-soluble film 30 by gravure printing, flexographic printing, or other appropriate printing means in advance in the case of general water pressure transfer and it may be in a dried and solidified state that has completely lost its adhesiveness before water pressure transfer in order to store the transfer film in a rolled state. This print pattern layer 40 may include a plain (no pattern) print layer as well as a pattern layer in the strict sense.

The concrete steps of this water pressure transfer method are shown in FIG. 2. In this method, before the print pattern layer 40 is transferred under water pressure onto the article 10 (see FIG. 2A), a solvent-based activating agent composition 60 is applied to the print pattern layer 40 of the transfer film 20 (see FIG. 2B), and the solvent content in the activating agent composition recovers (reproduces) the adhesiveness of the print pattern layer 40. The transfer film 20 having the print pattern layer 40 whose adhesiveness has been thus recovered by the activating agent composition 60 is transferred under water pressure onto the article 10 (see FIGS. 2C and 2D). Thereafter, as shown in FIG. 2E, the article 10 is washed with water using a shower 70 or the like to remove the water-soluble film (swelling dissolving film layer) covering the upper surface of the print pattern layer 40 (decorative layer 42) transferred onto the article 10, and further, as shown in FIG. 2F, the surface is dried by hot air 80 to transfer the print pattern layer 40 onto the surface of the article 10 to thereby form a decorative layer 42 by thus transferring the print pattern layer 40 onto the surface of the article 10 (see FIG. 3). In order to protect the decorative layer 42, a transparent top coat not shown may be further applied as required to complete the decorative article 12. For example, transparent or semi-transparent thermosetting paint or UV-curing paint may be used as the top coat.

The activating agent composition 60 used in the present invention may be a solvent-based composition that includes a resin component, a solvent component and a plasticizer component for essential components and this solvent-based composition may further include particles such as fine silica particles and other known additives as required.

The resin composition is used for providing an initial adhesion of the ink of the print pattern layer 40 to the substrate (the article to be pattern-transferred) and for preventing diffusion of the ink. The resin composition may include one or combination of either of (1) various oils and fats such as linseed oil, soybean oil and synthetic dry oil; (2) natural resins such as rosin, hardened rosin, rosin esters and polymerized rosin; (3) synthetic resins such as phenol resins, rosin-modified phenol resins, maleic acid resins, alkyd resins, petroleum resins, vinyl resins, acrylic resins, polyamide resins, epoxy resins, amino alkyd resins and fluoropolymers; (4) cellulose derivative such as nitrocellulose, cellulose acetate butyrate resin and ethyl cellulose; (5) rubber derivatives such as chlorinated rubber and cyclized rubber; and (6) other resin components such as casein, dextrin and zein (see Patent Document 4). Among these, there may be preferably used short oil alkyd resin and more preferably used short oil alkyd resin in combination with cellulose aceto-butyrate (CAB), the reason for which is as described in Patent Document 1 (see paragraph 0025 of the same document).

The solvent component serves to dissolve the ink in the print pattern layer 40 to thereby maintain the adhesion of the ink until the transfer of the print pattern layer is completed, and it may be any suitable solvent component used in conventional solvent-based activating agent compositions. However, it may be preferable to use a hydrophobic solvent in order to supplement an improvement on close contact of the transfer film around the surface of the article (throwing ability) and adhesion of the transfer film to the surface of the article during transfer, among four requirements that will be discussed later in relation to the plasticizer. The hydrophobic solvents may be preferably used because they have the additional effect of reducing water mark defects in addition to improving on contact of the transfer film onto the surface of the article and adhesion of the transfer film to the surface of the article. The hydrophobic solvents may be conventional solvents such as esters (e.g., methyl acetate, ethyl acetate or n-butyl acetate), ethers (e.g., diethyl ether or butyl ether), non-aromatic hydrocarbons (e.g., n-hexane or cyclohexane), aromatic hydrocarbons (e.g., toluene) and cyclic ketones. Specifically, at least an acetate ester solvent may be preferably used, but more preferably, the solvent comprising an acetate ester solvent and a cyclic ketone solvent may be used. In this case, the desirable blend ratio (weight ratio) of the cyclic ketone solvent to the acetate ester solvent may be 0.06 to 1. A conventional mixture of hydrophilic and hydrophobic solvents such as butyl cellosolve may be used.

Preferable hydrophobic solvents may be acetate solvents which are conventionally used in conventional solvent-based activating agents and more particularly butylcarbitol acetate (BCA), but it may be more preferable to further combine it with hydrophobic solvents having a solubility (SP value) close to the SP value (solubility parameter) of the base material of the article. The hydrophobic solvents that are to be preferably combined with butylcarbitol acetate (BCA) may be generally cyclic ketones, but it may be preferably cyclohexanone or cyclopentanone in the case where the base material of the article is ABS resin or polycarbonate (PC). In the case where cellulose acetobutyrate which has relatively little compatibility with butylcarbitol acetate is added to the resin component of the activating agent, the cyclic ketone may be preferably cyclohexanone or cyclopentanone which can easily dissolve cellulose aceto-butyrate.

The preferable blend ratio of the resin component and the solvent component has the resin component of 4-15 weight % relative to the total resin and solvent components (in other words, the weight ratio of the resin to the solvent is 1:24 to 1:6). The reason for this is that if the resin component is less than 4% by weight, then the transfer layer (print pattern layer) has a poor adhesion to the base material and there will be more likely to occur defects such as poor ink retention and pattern collapse, and if the resin component is more than 15% by weight, then the applicability and the ink solubility of the activating agent decrease, which makes it difficult to perform good ink activation.

The plasticizer component is for providing a plasticity to the resin component of the ink to ensure the extensibility of the print pattern layer when transferred. In order to avoid the use of dibutyl phthalate (DBP) which has been used in conventional technology and is regarded as a substance of high concern in terms of environmental load under the REACH Act and in order to satisfy or somewhat satisfy the seven conditions described below, the plasticizer used in the present invention is a non-aromatic carboxylic acid ester or carboxylic acid ether ester having two or more carboxylate groups and having a molecular weight ratio (ΣSMW/MW) of 0.3 or more which is calculated by dividing the sum (SMW) of the molecular weights (MW) of the terminal side aliphatic hydrocarbon groups forming ester bond and/or the furthest terminal side aliphatic hydrocarbon groups forming ether bond by the molecular weight (MW) of the carboxylic acid ester or carboxylic acid ether ester. In particular, in the case where the molecular weight ratio (ΣSMW/MW) is 0.45 or more, it is more effective in the suppression of bubbles during film removal, the extensibility of the transfer film during water pressure transfer and the surface properties of the water pressure transfer product.

(1) The transparency of the decorative layer of the water pressure transfer product is not affected (transparency).
(2) Ink shift of the printing layer does not occur when the transfer film swells in the water pressure transfer tank (ink shift).
(3) The decorative layer of the water pressure transfer product has low glass opacity and high transparency of (glass opacity).
(4) No bubbles are generated when the carrier film of the transfer film is removed from the water pressure transfer products (film removal bubbles).
(5) There is no interference with the extensibility of the transfer film within the water pressure transfer tank (extensibility).
(6) There has little stickiness on the surface of the water pressure transfer product (surface properties).
(7) The decorative layer will not be eroded by volatile oil (volatile oil resistance).

The non-aromatic carboxylic acid ester or carboxylic acid ether ester having two or more carboxylate groups that can be used in the present invention are carboxylic acid derivatives excluding maleic and succinic acid anhydrides and examples of them include bis(2-ethylhexyl) maleate (abbreviation DOM), diethyl succinate (abbreviation DESU), bis(2-butoxyethyl) adipate (product name D931), 4-cyclohexene-1,2-dicarboxylic acid bis(2-ethylhexyl) (abbreviation DOTH), di-2-ethylhexyl epoxy hexa-hydro-phthalate (product name E-PS), dibutyl maleate (abbreviation DBM) and tributyl acetyl citrate (abbreviation ATBC). In the subsequent descriptions, the specific plasticizer components used in the present invention will be expressed by abbreviation or product name.

The plasticizer component may be composed of a main plasticizer component and a single or multiple sub-plasticizer components by selecting two or more kinds of non-aromatic carboxylic acid ester and carboxylic acid ether ester having two or more carboxylate groups. The main plasticizer component provides basic functions of the activating agent (aforementioned requirements (1), (2) and (5)) such as plasticization of the ink in the print pattern and film extensibility during water pressure transfer and also a function of inhibiting the generation of film removal bubbles while the sub-plasticizer component provides the enhancement of the inhibiting action of bubble generation during film removal and the adjustment of the volatile oil resistance and the surface properties.

Among the specific plasticizer components listed above, DOM and D931 are suitable for the main plasticizer component while E-PS, DBM and ATBC are suitable for the sub-plasticizer component.

Regarding the molecular weight ratio of the main plasticizer component and the sub-plasticizer component relative to the total plasticizer component, the molecular weight ratio of the sub-plasticizer component may be desirably smaller than that of the main plasticizer component. In this case, the difference between the molecular weight ratio of the main plasticizer component and that of the sub-plasticizer component is preferably 0.05 to 0.25, more preferably 0.10 to 0.20, furthermore preferably 0.10 to 0.20 and especially more preferably 0.13 to 0.17. If the difference is less than 0.05, then, in some cases, the glass opacity will be higher, the extensibility and the surface properties will be poor and there will occur uneven application of the activating agent during water pressure transfer. On the other hand, if the difference is more than 0.25, then, in some cases, the suppression of the generation of film removal bubbles will be lower and the extensibility will be poor.

In the present invention, the weight ratio of the plasticizer component relative to the entire activating agent composition is preferably 13 to 25% and more preferably 15 to 22%. If the weight ratio is less than 13%, then, in some cases, there will occur poor adhesion of the print layer to the product in addition to the poor suppression of film removal bubbles and the poor extensibility. On the other hand, if the weight ratio exceeds 25%, then, in some cases, the surface properties and volatile oil resistance will be lower and the ink may be excessively plasticized during water pressure transfer, which will easily cause ink strain.

In the cases where the plasticizer comprises a main plasticizer component and a sub-plasticizer component, the weight ratio of the main plasticizer component relative to the total plasticizer may be preferably 65 to 80% and more preferably 68 to 76%. If this weight ratio is less than 65%, then, in some cases, the basic functions of the activating agent will be degraded and if it exceeds 80%, then, although depending on the combination of types of the main plasticizer component and the sub-plasticizer component, in some cases, the surface properties and the volatile oil resistance will be poor.

The preferable blend ratio of the plasticizer may be preferably 13 to 25% by weight relative to the entire activating agent composition for water pressure transfer. If the blend ratio of the plasticizer is less than 13%, then, in some cases, the suppression of film removal bubbles and the extensibility of the transfer film when activated will decrease and the adhesiveness of the decorative layer formed on the surface of the article will decrease. If the blend ratio of the plasticizer exceeds 25%, then, in some cases, the volatile oil resistance and the surface properties of the decorative layer formed on the surface of the article will be degraded and there tends to occur the pattern distortion during water pressure transfer due to the excessive plasticization of the ink of the print pattern.

A fine particle silica, which may be further added to the essential components of the activating agent composition, has the function of thickening the viscosity of the ink for preventing dust, etc., from adhering to the activated ink to make the ink surface apparently dry and of imparting thixotropy to the ink to prevent the ink strain while maintaining the extensibility of the ink. The particulate silica may be any known hydrophilic particulate silica used in conventional activating agents, such as AEROSIL (registered trademark) R9200 manufactured by AEROSIL Japan, for example.

To the extent that the effects of the invention are not impaired, known additives such as constitutional pigments, leveling agents, and matting agents may be added to the activating agent composition of the present invention.

### EXAMPLES

### Examples 1 to 20 and Comparisons 1 to 8

Specific concrete Examples 1 to 20 (Tables 1 to 4) of the present invention will be explained in comparison with Comparisons (Comparative Examples) 1 to 8 (Tables 5 and 6). In all the Examples and Comparisons, water pressure transfer was performed according to the steps shown in FIG. 2, except that the activating agent compositions were different. In both Examples and Comparisons, a 25±5 μm urethane UV curable transparent top coat (PG2455A-N7 clear manufactured by Fujikura, Japan) was applied to the surface of the water pressure transfer surface (decorative layer) by a separate step. In Tables 1 through 4, “EX” is an abbreviation of “Example” while in Tables 5 and 6, “COM” is an abbreviation of “Comparison”.

TABLE 1

| ACTIVATING AGENT COMPOSITION | | | | EX 1 | EX 2 | EX 3 | EX 4 | EX 5 |
|---|---|---|---|---|---|---|---|---|
| Resin | | Blend ratio | Weight part | 12.9 | 12.9 | 12.9 | 12.9 | 12.9 |
| Solvent | | Blend ratio | Weight part | 67.5 | 67.5 | 67.5 | 67.5 | 67.5 |
| Plasticizer | Main | Component | — | DOM | DESU | D931 | DOM | DOM |
| | plasticizer | Molecular weight | — | 340.5 | 174.2 | 346.5 | 340.5 | 340.5 |
| | component | Hydrophobic molecular weight | — | 226.4 | 58.1 | 114.2 | 226.4 | 226.4 |
| | (A) | Molecular weight ratio A | — | 0.67 | 0.33 | 0.33 | 0.67 | 0.67 |
| | | Blend ratio A | Weight part | 18.4 | 18.4 | 18.4 | 9.2 | 9.2 |
| | Sub- | Component | — | — | — | — | DESU | DBM |
| | plasticizer | Molecular weight | — | — | — | — | 174.2 | 228.3 |
| | component | Hydrophobic molecular weight | — | — | — | — | 58.1 | 114.2 |
| | (B) | Molecular weight ratio B | — | — | — | — | 0.33 | 0.50 |
| | | Blend ratio B | Weight part | 0 | 0 | 0 | 9.2 | 9.2 |

| | | | | | | |
|---|---|---|---|---|---|---|
| Blend ratio (A + B) | Weight part | 18.4 | 18.4 | 18.4 | 18.4 | 18.4 |
| Blend ratio (/entire activating agent) | [%] | 18.4 | 18.4 | 18.4 | 18.4 | 18.4 |
| Blend ratio A/(A + B) | [%] | 100 | 100 | 100 | 50 | 50 |
| Difference of molecular weight ratio (A − B) | — | — | — | — | 0.33 | 0.16 |

| | | | | | | | |
|---|---|---|---|---|---|---|---|
| Fine silica particles | Blend ratio | Weight part | 1.2 | 1.2 | 1.2 | 1.2 | 1.2 |

| | | | | | | |
|---|---|---|---|---|---|---|
| Evaluation items | Transparency | ◯ | ◯ | ◯ | ◯ | ◯ |
| | Ink shift | ◯ | ◯ | ◯ | ◯ | ◯ |
| | Glass opacity | ◯ | ◯ | Δ | ◯ | ◯ |
| | Film removal bubbles | ⊚ | Δ | Δ | Δ | Δ |
| | Extensibility | Δ | Δ | ◯ | Δ | ◯ |
| | Surface properties | Δ | ◯ | Δ | Δ | ◯ |
| | Volatile oil resistance | Δ | ◯ | ◯ | ◯ | ◯ |

TABLE 2

| ACTIVATING AGENT COMPOSITION | | | | EX 6 | EX 7 | EX 8 | EX 9 | EX10 |
|---|---|---|---|---|---|---|---|---|
| Resin | | Blend ratio | Weight part | 12.9 | 12.9 | 12.9 | 12.9 | 12.9 |
| Solvent | | Blend ratio | Weight part | 67.5 | 67.5 | 67.5 | 67.5 | 67.5 |
| Plasticizer | Main | Component | — | DOM | DOM | DOM | DOTH | E-PS |
| | plasticizer | Molecular weight | — | 340.5 | 340.5 | 340.5 | 394.6 | 410.6 |
| | component | Hydrophobic molecular weight | — | 226.4 | 226.4 | 226.4 | 226.4 | 226.4 |
| | (A) | Molecular weight ratio A | — | 0.67 | 0.67 | 0.67 | 0.57 | 0.55 |
| | | Blend ratio A | Weight part | 12.3 | 12.3 | 13.8 | 13.8 | 13.8 |
| | Sub- | Component | — | DESU | DBM | DBM | E-PS | DBM |
| | plasticizer | Molecular weight | — | 174.2 | 228.3 | 228.3 | 410.6 | 228.3 |
| | component | Hydrophobic molecular weight | — | 58.1 | 114.2 | 114.2 | 226.4 | 114.2 |
| | (B) | Molecular weight ratio B | — | 0.33 | 0.50 | 0.50 | 0.55 | 0.50 |
| | | Blend ratio B | Weight part | 6.1 | 6.1 | 4.6 | 4.6 | 4.6 |

| | | | | | | |
|---|---|---|---|---|---|---|
| Blend ratio (A + B) | Weight part | 18.4 | 18.4 | 18.4 | 18.4 | 18.4 |
| Blend ratio (/entire activating agent) | [%] | 18.4 | 18.4 | 18.4 | 18.4 | 18.4 |
| Blend ratio A/(A + B) | [%] | 67 | 67 | 75 | 75 | 75 |
| Difference of molecular weight ratio (A − B) | — | 0.33 | 0.16 | 0.16 | 0.02 | 0.05 |

| | | | | | | | |
|---|---|---|---|---|---|---|---|
| Fine silica particles | Blend ratio | Weight part | 1.2 | 1.2 | 1.2 | 1.2 | 1.2 |

| | | | | | | |
|---|---|---|---|---|---|---|
| Evaluation items | Transparency | ◯ | ◯ | ◯ | ◯ | ◯ |
| | Ink shift | ◯ | ◯ | ◯ | ◯ | ◯ |
| | Glass opacity | ◯ | ◯ | ◯ | Δ | Δ |
| | Film removal bubbles | ⊚ | ⊚ | ⊚ | ◯ | ◯ |
| | Extensibility | Δ | ◯ | ⊚ | Δ | ◯ |
| | Surface properties | Δ | ⊚ | ⊚ | Δ | ◯ |
| | Volatile oil resistance | Δ | ◯ | ◯ | ◯ | ◯ |

TABLE 3

| ACTIVATING AGENT COMPOSITION | | | | EX11 | EX12 | EZ13 | EX14 | EX15 |
|---|---|---|---|---|---|---|---|---|
| Resin | | Blend ratio | Weight part | 12.9 | 12.9 | 12.9 | 12.9 | 12.9 |
| Solvent | | Blend ratio | Weight part | 67.5 | 67.5 | 75.9 | 72.4 | 61.4 |
| Plasticizer | Main | Component | — | DOM | DOTH | DOM | DOM | DOM |
| | plasticizer | Molecular weight | — | 340.5 | 394.6 | 340.5 | 340.5 | 340.5 |
| | component | Hydrophobic molecular weight | — | 226.4 | 226.4 | 226.4 | 226.4 | 226.4 |
| | (A) | Molecular weight ratio A | — | 0.67 | 0.57 | 0.67 | 0.67 | 0.67 |
| | | Blend ratio A | Weight part | 13.8 | 13.8 | 7.5 | 10 | 17.5 |
| | Sub- | Component | — | ATBC | DESU | DBM | DBM | DBM |
| | plasticizer | Molecular weight | — | 402.5 | 174.2 | 228 | 228 | 228 |
| | component | Hydrophobic molecular weight | — | 186.4 | 58.1 | 114 | 114 | 114 |
| | (B) | Molecular weight ratio B | — | 0.46 | 0.33 | 0.50 | 0.50 | 0.50 |
| | | Blend ratio B | Weight part | 4.6 | 4.6 | 2.5 | 3.5 | 7.0 |

| | | | | | | |
|---|---|---|---|---|---|---|
| Blend ratio (A + B) | Weight part | 18.4 | 18.4 | 10 | 13.5 | 24.5 |
| Blend ratio (/entire activating agent) | [%] | 18.4 | 18.4 | 10 | 13.5 | 24.5 |
| Blend ratio A/(A + B) | [%] | 75 | 75 | 75 | 74 | 71 |
| Difference of molecular weight ratio (A − B) | — | 0.20 | 0.24 | 0.16 | 0.16 | 0.16 |

| | | | | | | | |
|---|---|---|---|---|---|---|---|
| Fine silica particles | Blend ratio | Weight part | 1.2 | 1.2 | 1.2 | 1.2 | 1.2 |

| | | | | | | |
|---|---|---|---|---|---|---|
| Evaluation items | Transparency | ◯ | ◯ | ◯ | ◯ | ◯ |
| | Ink shift | Δ | ◯ | ◯ | ◯ | ◯ |
| | Glass opacity | ◯ | ◯ | ◯ | ◯ | ◯ |
| | Film removal bubbles | ◯ | Δ | Δ | ◯ | ◯ |
| | Extensibility | ◯ | Δ | ◯ | ◯ | ◯ |
| | Surface properties | ◯ | ◯ | ◯ | ◯ | ◯ |
| | Volatile oil resistance | ◯ | ◯ | ◯ | ◯ | ◯ |

TABLE 4

| ACTIVATING AGENT COMPOSITION | | | | EX16 | EX17 | EX18 | EX19 | EX20 |
|---|---|---|---|---|---|---|---|---|
| Resin | | Blend ratio | Weight part | 12.9 | 12.9 | 12.9 | 12.9 | 12.9 |
| Solvent | | Blend ratio | Weight part | 55.9 | 67.5 | 67.5 | 67.5 | 67.5 |
| Plasticizer | Main | Component | — | DOM | DOM | DOM | DOM | DOM |
| | plasticizer | Molecular weight | — | 340.5 | 340.5 | 340.5 | 340.5 | 340.5 |
| | component | Hydrophobic molecular weight | — | 226.4 | 226.4 | 226.4 | 226.4 | 226.4 |
| | (A) | Molecular weight ratio A | — | 0.67 | 0.665 | 0.665 | 0.665 | 0.665 |
| | | Blend ratio A | Weight part | 22.5 | 11.6 | 12.5 | 14.5 | 15.5 |
| | Sub- | Component | — | DBM | DOTH | DOTH | DOTH | DOTH |
| | plasticizer | Molecular weight | — | 228 | 394.6 | 394.6 | 394.6 | 394.6 |
| | component | Hydrophobic molecular weight | — | 114 | 226.4 | 226.4 | 226.4 | 226.4 |
| | (B) | Molecular weight ratio B | — | 0.50 | 0.57 | 0.57 | 0.57 | 0.57 |
| | | Blend ratio B | Weight part | 7.5 | 6.8 | 5.9 | 3.9 | 2.9 |

| | | | | | | |
|---|---|---|---|---|---|---|
| Blend ratio (A + B) | Weight part | 30 | 18.4 | 18.4 | 18.4 | 18.4 |
| Blend ratio (/entire activating agent) | [%] | 30 | 18.4 | 18.4 | 18.4 | 18.4 |
| Blend ratio A/(A + B) | [%] | 75 | 63 | 68 | 79 | 84 |
| Difference of molecular weight ratio (A − B) | — | 0.16 | 0.09 | 0.09 | 0.09 | 0.09 |

| | | | | | | | |
|---|---|---|---|---|---|---|---|
| Fine silica particles | Blend ratio | Weight part | 1.2 | 1.2 | 1.2 | 1.2 | 1.2 |

| | | | | | | |
|---|---|---|---|---|---|---|
| Evaluation items | Transparency | ◯ | ◯ | ◯ | ◯ | ◯ |
| | Ink shift | ◯ | Δ | ◯ | ◯ | ◯ |
| | Glass opacity | ◯ | ◯ | ◯ | ◯ | ◯ |
| | Film removal bubbles | ◯ | Δ | ◯ | ◯ | Δ |
| | Extensibility | ◯ | Δ | ◯ | ◯ | ◯ |
| | Surface properties | Δ | Δ | ◯ | ◯ | Δ |
| | Volatile oil resistance | Δ | Δ | ◯ | ◯ | Δ |

TABLE 5

| ACTIVATING AGENT COMPOSITION | | | | COM 1 | COM 2 | COM 3 | COM 4 | COM 5 |
|---|---|---|---|---|---|---|---|---|
| Resin | | Blend ratio | Weight part | 12.9 | 12.9 | 12.9 | 12.9 | 12.9 |
| Solvent | | Blend ratio | Weight part | 67.5 | 67.5 | 67.5 | 67.5 | 67.5 |
| Plasticizer | Main | Component | — | W-260 | DOM | DMP | DBP | DBP |
| | plasticizer | Molecular weight | — | 434.6 | 340.5 | 194.2 | 278.3 | 278.3 |
| | component | Hydrophobic molecular weight | — | 114.2 | 226.4 | 30.1 | 114.2 | 114.2 |
| | (A) | Molecular weight ratio A | — | 0.26 | 0.67 | 0.15 | 0.41 | 0.41 |
| | | Blend ratio A | Weight part | 18.4 | 9.2 | 18.4 | 18.4 | 9.2 |
| | Sub- | Component | — | — | W260 | — | — | DMP |
| | plasticizer | Molecular weight | — | — | 434.6 | — | — | 194.2 |
| | component | Hydrophobic molecular weight | — | — | 114.2 | — | — | 30.1 |
| | (B) | Molecular weight ratio B | — | — | 0.26 | — | — | 0.15 |
| | | Blend ratio B | Weight part | 0 | 9.2 | 0 | 0 | 9.2 |

| | | | | | | |
|---|---|---|---|---|---|---|
| Blend ratio (A + B) | Weight part | 18.4 | 18.4 | 18.4 | 18.4 | 18.4 |
| Blend ratio (/entire activating agent) | [%] | 18.4 | 18.4 | 18.4 | 18.4 | 18.4 |
| Blend ratio A/(A + B) | [%] | 100 | 50 | 100 | 100 | 50 |
| Difference of molecular weight ratio (A − B) | — | — | 0.40 | — | — | 0.26 |

| | | | | | | | |
|---|---|---|---|---|---|---|---|
| Fine silica particles | Blend ratio | Weight part | 1.2 | 1.2 | 1.2 | 1.2 | 1.2 |

| | | | | | | |
|---|---|---|---|---|---|---|
| Evaluation items | Transparency | ◯ | ◯ | ◯ | ◯ | ◯ |
| | Ink shift | ◯ | ◯ | ◯ | ◯ | ◯ |
| | Glass opacity | Δ | ◯ | ◯ | X | Δ |
| | Film removal bubbles | X | X | X | ⊚ | X |
| | Extensibility | ◯ | Δ | X | ◯ | X |
| | Surface properties | Δ | Δ | ⊚ | X | Δ |
| | Volatile oil resistance | ◯ | Δ | ◯ | ◯ | ◯ |

TABLE 6

| ACTIVATING AGENT COMPOSITION | | | | COM 6 | COM 7 | COM 8 |
|---|---|---|---|---|---|---|
| Resin | | Blend ratio | Weight part | 12.9 | 12.9 | 12.9 |
| Solvent | | Blend ratio | Weight part | 67.5 | 67.5 | 67.5 |
| Plasticizer | Main | Component | — | DBP | PB-3A | TCP |
| | plasticizer | Molecular weight | — | 278.3 | 314.33 | 368.36 |
| | component | Hydrophobic molecular weight | — | 114.2 | 154.2 | 273.4 |
| | (A) | Molecular weight ratio A | — | 0.41 | 0.49 | 0.74 |
| | | Blend ratio A | Weight part | 13.8 | 18.4 | 18.4 |
| | Sub- | Component | — | DMP | — | — |
| | plasticizer | Molecular weight | — | 194.2 | — | — |
| | component | Hydrophobic molecular weight | — | 30.1 | — | — |
| | (B) | Molecular weight ratio B | — | 0.15 | — | — |
| | | Blend ratio B | Weight part | 4.6 | 0 | 0 |

| | | | | |
|---|---|---|---|---|
| Blend ratio (A + B) | Weight part | 18.4 | 18.4 | 18.4 |
| Blend ratio (/entire activating agent) | [%] | 18.4 | 18.4 | 18.4 |
| Blend ratio A/(A + B) | [%] | 75 | — | — |
| Difference of molecular weight ratio (A − B) | — | 0.26 | — | — |

| | | | | | |
|---|---|---|---|---|---|
| Fine silica particles | Blend ratio | Weight part | 1.2 | 1.2 | 1.2 |

| | | | | |
|---|---|---|---|---|
| Evaluation items | Transparency | ◯ | ◯ | X |
| | Ink shift | ◯ | ◯ | X |
| | Glass opacity | X | ◯ | ◯ |
| | Film removal bubbles | Δ | X | Δ |
| | Extensibility | Δ | ◯ | ◯ |
| | Surface properties | Δ | Δ | ◯ |
| | Volatile oil resistance | ◯ | Δ | ⊚ |

The transfer film, the activating agent and the object to be pattern-transferred used in the Examples and the Comparisons were as follows.

### (1) Transfer Film

There was used the water pressure transfer film called “Creation Light Oak 2C,” which has been supplied by the applicant to licensees. This transfer film was formed by applying a print pattern layer of wood grain pattern (with the solvent component volatilized and removed) to the transfer surface side of the PVA film by gravure printing using solvent-based ink comprising a mixture of pigments and synthetic resin.

### (2) Activating Agent and its Coating (Applying) Conditions

The activating agent used in the Examples of the present inventions and the Comparisons was provided with the compositions shown in Tables 1-6 compounded for each of the Examples and Comparisons using the plasticizers of Table 7, the resin components of Table 8, the solvent components and the fine silica particles. The activating agent was coated on the transfer film described in paragraph (1) by gravure roll coating method to a thickness of 12 μm.

### (3) Object to be Pattern-Transferred

There were used both of a flat plate of 100 mm×200 mm×3 mm made of ABS resin (TM20 manufactured by UMG ABS Co., Ltd.) and a flat plate of 100 mm×200 mm×3 mm made of PC/ABS resin (CK50 manufactured by Techno Polymer Co., Ltd.) as the articles to be pattern-transferred. The quality of the pattern-transferred articles, which varied depending on these flat plates, was used for the evaluation results.

TABLE 7
(List of plasticizers)

| | | | | Hydrophobic |
|---|---|---|---|---|
| | | | Molecular | molecular |
| SYMBOL | COMPONENT | Maker | weight | weight |
| DOM | bis(2-ethylhexyl) maleate | Daihachi | 340.5 | 226.4 |
| | | Chemical | | |
| DESU | diethyl succinate | Daihachi | 174.2 | 58.1 |
| | | Chemical | | |
| D931 | bis(2-butoxyethyl) adipate | Mitsubishi | 346.5 | 114.2 |
| | | Chemical | | |
| DOTH | 4-cyclohexene-1,2-dicarboxylic acid | New Japan | 394.6 | 226.4 |
| | bis(2-ethylhexyl) | Chemical | | |
| E-PS | di-2-ethylhexyl epoxy hexa- | New Japan | 410.6 | 226.4 |
| | hydro-phthalate | Chemical | | |
| DBM | dibutyl maleate | Daihachi | 228 | 114 |
| | | Chemical | | |
| ATBC | tributyl acetyl citrate | Mitsubishi | 402.5 | 186.4 |
| | | Chemical | | |
| W260 | bis(2-(2-butoxyethoxy)ethyl adipate | DIC Corporation | 434.6 | 114.2 |
| DMP | dimethyl phthalate | Daihachi | 194.2 | 30.1 |
| | | Chemical | | |
| DBP | dibutyl phthalate | Daihachi | 278.3 | 114.2 |
| | | Chemical | | |
| PB-3A | benzoic acid diester | DIC Corporation | 314.33 | 154.2 |
| TCP | tricresylphosphate | Daihachi | 368.36 | 273.4 |
| | | Chemical | | |

TABLE 8
(List of components other than plasticizers)

| | | | | BLEND BREAKDOWN | |
|---|---|---|---|---|---|
| MATERIAL | OMPONENT | MAKER | BRAND NAME | (Weight part) | |
| Resin | short oil alkyd resin | DIC Corporation | BECKLITE | 12.3 | Total |
| | | | (Registered | | 12.9 |
| | | | trademark) | | |
| | | | 46-118 | | |
| | cellulose acetobutyrate | Eastman Chemical | CAB-381-0.5 | 0.6 | |
| Solvent | butyl cellosolve | Sankyo Chemical | Butyl Cellosolve | 18.4 | Total |
| | | | (99% or more) | | 67.5 |
| | butyl carbitol acetate | Sankyo Chemical | Butyl carbitol | 49.1 | |
| | | | acetate | | |

| | | | | |
|---|---|---|---|---|
| Silica | hydropholic silica | Nippon Aerosil | Aerosil | — |
| | | | (Registered | |
| | | | trademark) | |
| | | | R9200 | |

Each of evaluation methods in the results of “Evaluation” in Tables 1 to 6 is as follows. In the evaluation methods, “⊚” (optimum), “∘” (suitable), and “Δ” (slightly suitable) indicate that the products are preferable or have no problem in practical use, while “x” (incompatible) indicates that the products are not practical.

### (Transparency)

There were visually confirmed the transparency and the sharpness of the activating agent used in the Examples and Comparisons and the print pattern layer of the wetted transfer film obtained using these activating agents. The case where the transparency and the sharpness of both of the activating agents themselves and the print pattern layers themselves were confirmed was expressed by the symbol of “∘” while the case where the inferior transparency and the inferior sharpness due to the cloudiness of the activating agent composition itself and the activating agent composition that became a semi-dry film on the transfer film due to the rapid volatilization of the solvent, and due to the inhibition of the sharpness of the print pattern layer of the transfer film were confirmed was expressed by the symbol of “X”.

### (Ink Shift)

There was confirmed the presence or absence of the state in which the print pattern layer was distorted, flown or collapsed when the carrier film (base film) of the transfer film was floated on the water surface in the water tank with the surface of the transfer film where the activating agent composition was coated upward directed to swell by water absorption and at the same time the carrier film was swelled by the activating agent composition for the print pattern layer. It was visually confirmed whether the print pattern layer was evenly expanded after swelling and had no curvature or distortion. The case where the print pattern layer was evenly expanded after swelling without any curve or distortion was expressed by the symbol of “∘”; the case where there was no curve or distortion anywhere in the print pattern layer but the print pattern layer was not expanded evenly was expressed by the symbol of “Δ” and the case where there was curve or distortion somewhere in the print pattern layer and the print pattern layer was not expanded evenly was expressed by the symbol of “X”.

### (Glass Opacity)

A test piece was placed in a beaker and covered with a dedicated glass plate in a glass fogging test apparatus according to ISO-6452, and there was evaluated the state of fogging of the dedicated glass plate due to adhesion of volatile components of the test piece when the inside of the beaker was heated at a heating temperature of 100° C. for 20 hours. The test pieces were formed by performing the water pressure transfer to an ABS substrate using the activating agent compositions of the Examples and Comparisons, followed by applying a top coat on the print pattern layer. The size of the test pieces was 100 mm×50 mm×0.012 mm, which is different from the size used in the Examples and Comparisons. The treatment was carried out at a heating temperature of 100° C. for a heating time of 20 hours. The cloudy state (glass fogginess) of the dedicated glass plates was evaluated by a haze value (degree of opacity) measured using an integrating sphere type light transmittance measurement device (direct reading haze computer manufactured by Suga Test Instruments Co., Ltd.) specified in JIS-K7105. The case where the haze value was 5% or less was expressed by the symbol of “∘”, the case where the haze value was 10% or less was expressed by the symbol of “Δ” and the case where the haze value was more than 10% was expressed by the symbol of “x”.

### (Film Removal Bubbles)

Water of 700 kg was collected in a film removal tank, polyvinyl alcohol (PVA) of 1.4 kg was dissolved so as to obtain a concentration of 2000 ppm and the activating agent of 400 g to be evaluated was mixed. Thereafter, the film removal cleaning or washing started while showering by water circulation and there was measured over time the bubble height uplift rate (uplift speed) HR [cm/min] during the film removal cleaning in the film removal water tank. The case where the HR was 0.3 cm/min or less was expressed by the symbol “⊚”; the case where HR was 0.5 cm/min or less, but more than 0.3 cm/min was expressed by the symbol “∘”, the case where the HR was 1.0 cm/min or less, but more than 0.5 cm/min was expressed by the symbol “Δ”; and the case where the HR was more than 1.0 cm/min was expressed by the symbol “x”.

### (Extensibility)

When the transfer film (of width of 510 mm) coated with the activating agent composition was floated on the water surface of the water pressure transfer tank, the base film of the transfer film swelled with water and at the same time, the print pattern layer also swelled with the activating agent composition, which causes the transfer film to elongate and expand uniformly to a certain expansion rate as a whole. There was measured a distance D between guide chains (of width of 650 mm) of the water pressure transfer tank and the swollen edge of the film at the transfer position (at the position far away 3200 mm from the film landing position). The case where the D was 0 cm (meaning the film reached the guide chains) was expressed by the symbol “⊚,” the case where the D was less than 5 cm was expressed by the symbol “∘,”, the case where was 5 cm or more, but less than 8 cm was expressed by the symbol “Δ”, and the case where the D was 8 cm or more was expressed by the symbol “x”.

### (Surface Properties)

The print pattern layer was transferred under water pressure onto 10 flat plates of ABS resin and of size of 200 mm×100 mm using the activating agent compositions of the Examples and Comparisons. The number of foreign substances adhering to the flat plate after removal of the remaining base film and volatilization of the solvent content in the ink and the activating agent composition by the shower or hot air in the film removal step was visually observed and evaluated. Those with strong surface stickiness had a large number of foreign substances, while those without stickiness had few or no foreign substances observed. The case where no foreign substances were observed on any of the plates was expressed by the symbol of “⊚,” the case where the number of the flat plates with foreign substances confirmed was 3 or less was expressed by the symbol of “∘,” the case where the number of the flat plates with foreign substances confirmed was four or five was expressed by the symbol of “Δ”, and the number of the flat plates with foreign substances confirmed was six or more was expressed by the symbol of “x”.

### (Volatile Oil Resistance)

A polyethylene cylinder (inner diameter of 3 cm) was fixed onto a sample of the water pressure transfer product and No. 1 volatile oil (n-hexane:n-heptane=1:1) of 5 ml was dropped into the cylinder and left in contact with the surface of the sample for 24 hours at a temperature of 20 f 2° C. The sample was then washed with water and dried with air. The color difference of the cylinder and the state of the coating surface (discoloration, wrinkles, cracks, etc.) of the part of the sample that had been in contact with the volatile oil were visually checked, and the color difference [symbol] E from the part that had not been in contact with the volatile oil was evaluated. The case where there was no problem with the coating surface of the sample and the color difference [symbol] E was 1.5 or less was expressed by the symbol of “∘”, the case where there was no problem with the coating surface of the sample and the color difference [symbol] E was more than 1.5 was expressed by the symbol of “Δ” and the case where there was any problem with the coating surface of the sample regardless of the color difference [symbol] E was expressed by the symbol of “X”.

### (Evaluation Results)

The evaluation of the Examples and the Comparisons is as described in the “Evaluation” column of Tables 1 through 6 and these evaluation results will note the following matters.

(1) Examples 1 to 20 of the present invention in which the plasticizer is a non-aromatic carboxylic acid ester or carboxylic acid ether ester having two or more carboxylate groups, and a molecular weight ratio (ΣSMW/MW) calculated by dividing the sum of the molecular weights of the terminal side aliphatic hydrocarbon groups that form ester bonds and/or the furthest terminal side aliphatic hydrocarbon groups that form ether bonds (SMW) by the molecular weight (MW) of the carboxylic acid esters or carboxylic acid ether esters is 0.3 or more comply with the environmental regulations, which is the purpose of the present invention, and are suitable for all seven conditions for the evaluation of plasticizers afore-mentioned, namely, the transparency, the ink shift, the glass opacity, the film removal bubbles, the extensibility, the surface properties and the volatile oil resistance or have no problems in use as noted in contrast to Comparisons 1 to 6 which are out of the components of the present invention.
(2) According to Examples 1-3, in which the plasticizer component does not include the sub-plasticizer component, it will be noted that the larger the molecular weight ratio of the plasticizer is, the greater the effect of suppression of film removal bubbles is. Since the plasticizer component does not contain the sub-plasticizer component, the extensibility, the surface properties and the volatile oil resistance are slightly inferior, but there will be no problem in use.
(3) From the comparison of Examples 1-3 with Examples 5, 7, 8, 10-15, 18 and 19 in which the plasticizer component includes a sub-plasticizer component, it will be noted that the inclusion of the sub-plasticizer component improves the surface properties and the volatile oil resistance.
(4) Comparing Example Group (A) of Examples 5, 7, 8, 10-15, 18 and 19 with Example Group (B) of Examples 4, 6 and 9, it will be noted that Example Group (A) in which the difference of the molecular weight ratio between the main plasticizer component and the sub-plasticizer component is in the range of 0.05 to 0.25 is desirable from the viewpoint of improving the surface properties and the volatile oil resistance. On the other hand, it will be noted that Examples 4 and 6, in which the difference of the molecular weight ratio between the main plasticizer component and the sub-plasticizer component is 0.33 which exceeds the upper limit, have low extensibility and surface properties, even though they have no problem in use. According to Example 9, since the difference of the molecular weight ratio is 0.02 which is less than the lower limit, the glass opacity is poor even though there is no problem in use and in addition, according to Example 9, the extensibility and the surface properties tend to decrease even though there is no problem in use.
(5) According to Example 13, since the blend (weight) ratio of the plasticizer component to the entire activating agent composition is 10%, which is less than 13%, the lower limit of the preferred range, there is no problem in use, but there occurs some film removal bubbles. According to Examples 14 and 15, since they are within the preferred range of 13-25% of the plasticizer, it will be noted that all the conditions necessary for the plasticizer are met. However, according to Example 16, the blend ratio of the plasticizer is 30%, which is beyond the upper limit of the preferred range, it will be noted that the surface properties and the volatile oil resistance are inferior even though there is no problem in use.
(6) According to Examples 4, 5 and 17, in case where the blend (weight) ratio of the main plasticizer component in the plasticizer component is 50% (Examples 4 and 5) and 63% (Example 17), which are lower than the lower limit of the preferred range, it will be noted that there is no problem in use, but a small amount of film removal bubbles is found to occur. On the other hand, according to Examples 18 and 19, it will be found that the blend ratio of the main plasticizer component is within the preferred range of 65-80%, and therefore there is almost no generation of film removal bubbles and they are suitable for use.
(7) Among the Comparisons, Comparisons 3 through 6 do not comply with environmental regulations because they use phthalic acid-based plasticizer components, and Comparisons 1, 2, 7, and 8 comply with environmental regulations because they use plasticizer components other than phthalic acid-based components, but they cannot satisfy any one or more of the above seven conditions, indicating that they are outside the scope of the present invention.
(8) Looking over Examples 1 through 20, it can be seen that the plasticizer component comprises a main plasticizer component and a sub-plasticizer component, and that Examples 7, 8, 14, 15, 18 and 19, in which the blend (weight) ratio of the plasticizer component to the entire plasticizer composition, the difference of the molecular weight ratio of the main plasticizer component and the sub-plasticizer component, and the blend (weight) ratio of the main plasticizer component in the plasticizer component are within the favorable range, are suitable examples, and especially Examples 7 and 8 are the most suitable examples.

### INDUSTRIAL APPLICABILITY

The activating agent composition for water pressure transfer according to the present invention has high industrial applicability because the plasticizer component does not contain phthalic acid-based components, which means that it is free from regulations that would prohibit its use in the future, and because it does not cause or lessens the generation of film removal bubbles and satisfies other conditions necessary for the plasticizer, thus providing an activating agent suitable for water pressure transfer.

### DESCRIPTION OF THE REFERENCE NUMBERS

10 Object
20 Transfer film
30 Water-soluble film (carrier film)
40 Print pattern layer
50 Water
60 Solvent-based activating agent composition
70 Shower
80 Hot air

1. An activating agent composition for water pressure transfer, which is applied to a print pattern layer of a transfer film for water pressure transfer to activate the print pattern layer and comprises a resin component, a solvent component and a plasticizer component, and characterized by that the plasticizer component is a non-aromatic carboxylic acid ester or carboxylic acid ether ester having two or more carboxylate groups, and the molecular weight ratio obtained by dividing the sum of the molecular weights of the terminal side aliphatic hydrocarbon groups forming ester bonds and/or the furthest terminal side aliphatic hydrocarbon groups constituting ether bonds by the molecular weight of the carboxylic acid ester or carboxylic acid ether ester is 0.3 or more.

2. An activating agent composition for water pressure transfer as set forth in claim 1, wherein the plasticizer component comprises a main plasticizer component and a single or multiple sub-plasticizer components, and the sub-plasticizer component has a molecular weight ratio lower than that of the main plasticizer component.

3. An activating agent composition as set forth in claim 2, wherein the difference between the molecular weight ratio of the main plasticizer component and the molecular weight ratio of the sub-plasticizer component is between 0.05 and 0.25.

4. An activating agent composition as set forth in claim 1, wherein the weight ratio of the plasticizer component relative to the entire activating agent composition is 13-25%.

5. An activating agent composition as set forth in claim 2, wherein in the case where the plasticizer comprises the main plasticizer component and the sub-plasticizer component, the weight ratio of the main plasticizer component relative to the entire plasticizer is 65-80%.

6. An activating agent composition as set forth in claim 1, wherein the carboxylic acid constituting the carboxylic acid ester or carboxylic acid ether ester is selected from maleic acid and succinic acid.

7. A method for transferring under water pressure a print pastern layer of a water pressure transfer film onto an article by using an activating agent composition as set forth in claim 1.

8. A water pressure transfer article having a decorative layer obtained by water pressure transfer of a
print pattern layer of a water pressure transfer film according to claim 7.
